(19) United States
(12) Patent Application Publication
(10) Pub. No.: US 2004/0249923 A1
(43) Pub. Date: Dec. 9, 2004

(54) Efficient home network management system and method

(76) Inventors: Young-goo Ko, Seoul (KR); Hyun-gyoo Yook, Seoul (KR); Hyun-sik Yoon, Seoul (KR)

Correspondence Address: SUGHRUE MION, PLLC, 2100 PENNSYLVANIA AVENUE, N.W., SUITE 800, WASHINGTON, DC, 20037, US

(21) Appl. No.: 10/817,925

(22) Filed: Apr. 6, 2004

(30) Foreign Application Priority Data
Apr. 15, 2003 (KR) 10-2003-0023662

(51) Int. Cl. G06F 15/173

(52) U.S. Cl. 709/223

(57) ABSTRACT

A home network apparatus including a monitoring module for capturing advertisement packets, which are transmitted by home network components when the components are connected to a home network, and extracting a first list of home network components residing on the home network, and a list compare module for comparing the first list of the home network components extracted by the monitoring module and a second list of home network components extracted through a discovery process and extracting a third list indicating differences between the first and second lists. The list of all controlled devices connected to the home network is compared with the list of controlled devices extracted by a control point, and then, a list of controlled devices that were not extracted by the control point is provided to the control point. Thus, there is an advantage in that all controlled devices connected to the home network can be correctly discovered.

### BACKGROUND OF THE INVENTION

This application claims the priority of Korean Patent Application No. 10-2003-0023662 filed on Apr. 15, 2003, in the Korean Intellectual Property Office, the disclosure of which is incorporated herein in its entirety by reference.

1. Field of the Invention

The present invention relates to an efficient home network management system and method, and more particularly, to an efficient home network management system and method wherein all controlled devices connected to a home network can be correctly discovered by comparing a first list of all the controlled devices connected to the home network and a second list of the controlled devices extracted by a control point and then providing the control point with a third list indicating differences between the first and second lists.

2. Description of the Prior Art

Generally, a home network consists of an Internet protocol (IP) based private network. In such a home network, a variety of devices such as personal computers (PC), intelligent products and wireless devices, which are commonly used at home, are connected and controlled through a single network. Here, one of the methods for discovering the devices connected to the network and using the services thereof employs UPnP (universal plug and play) technology.

According to UPnP technology, any serviceable device connected to the network can be discovered to employ a desired service. This process is aptly called “discovery”. Here, the discovery may employ a multicast method for transferring a multicast packet to all the devices connected to the network and a UDP (user datagram protocol) method through which it is not confirmed whether the packet has been received.

In the aforementioned methods, however, it is not confirmed whether the packet has been received. Thus, referring to FIG. 14, the multicast packet is transmitted one or more times in preparation for a case where a control point (CP) 20 does not receive the multicast packet. A network whose connection status is unstable could not safely deliver the packet, and the packet may be lost during its delivery. Further, a controlled device (CD) 30 does not include a procedure for confirming the receipt of this packet and thus does not request retransmission of the packet. Furthermore, the control point 20 receives a response only from a controlled device that received the multicast packet and does not receive a response from any controlled devices that did not receive the multicast packet. As a result, the control point 20 cannot correctly discover all the controlled devices connected to the home network.

In addition, in a case where the UPnP control point 20 operates in a network (e.g., wireless network) whose connection status is unstable when discovering UPnP controlled devices 30 connected to the network, it is subject to the characteristic of the network. That is, in case of the wireless network, there is a high possibility that an error may happen in transferring the packet between an access point 15 and the terminal if the terminal moves away from the access point 15 in view of its inherent wireless characteristics. Accordingly, the multicast packet transmitted by the UPnP control point 20 for discovering the controlled device 30 may not be transferred to the controlled device 30. Otherwise, even though a controlled device that received the multicast packet has transmitted a relevant response, the packet may be lost when the response is transmitted to the control point 20. Thus, there is a problem in that the control point 20 cannot discover the controlled device 30 residing on a home network.

Further, in the case of a wired network, there is a problem in that the multicast packet transmitted by the control point 20 can be lost if a routing queue is in an overflow state in the switching unit. Even in such a case, since the multicast packet transmitted by the control point 20 for discovering the controlled device 30 employs UDP (user datagram protocol), a procedure for confirming whether a controlled device 30 has normally received the multicast packet is not provided. Thus, there is another problem in that the control point 20 cannot correctly discover the controlled device.

According to the conventional method for discovering UPnP controlled devices, therefore, it is determined that there is no relevant controlled device 30, in a case where the multicast packet is not transferred to the controlled device 30 or the control point 20 does not receive the response from the relevant controlled device 30 even though the controlled device 30 connected to the network actually exists. This causes great inconvenience to the user.

FIG. 14 illustrates a device discovery process based on UPnP technology. The system shown in the figure comprises a gateway 10, an access point 15, a controlled device 30 and a control point 20. Here, in order to discover a controlled device 30 connected to the network, the UPnP control point 20 transmits multicast packets to all the controlled devices connected to the network using the UDP-multicast method.

However, controlled devices 32, 34 and 35 connected to the network whose connection status is unstable cannot correctly receive the multicast packet, and the control point 20 does not confirm whether the multicast packet has correctly reached controlled devices 31, 32, . . . , 35.

Thus, the list of controlled devices obtained by the control point 20 is incorrect. Furthermore, a procedure for confirming whether the controlled devices have normally received the multicast packet is also not provided. Consequently, the control point 20 has difficulty in correctly discovering controlled devices 31, 32, . . . , 35.

### SUMMARY OF THE INVENTION

Accordingly, the present invention is conceived to solve the above problems. It is an object of the present invention to provide an efficient home network management system and method wherein all controlled devices connected to a home network can be correctly discovered by comparing a first list of all the controlled devices connected to the home network and a second list of the controlled device extracted by a control point and then providing the control device with a third list indicating differences between the first and second lists.

According to an aspect of the present invention for achieving the above object, there is provided a home network apparatus comprising a monitoring module for capturing advertisement packets transmitted by home network components when the components are connected to a home network and extracting a first list of the home network components residing on the home network. There is also provided a home network apparatus comprising a list compare module for comparing a first list of home network components residing on a home network and a second list of home network components extracted through a discovery process and extracting a third list of home network components indicating differences between the first and second lists. Preferably, the monitoring module comprises a capture module for capturing the advertisement packets transmitted from the home network components, and an information extraction module for analyzing the captured packets and extracting the first list of the home network components. More preferably, the list compare module comprises a reachability check module for checking whether the home network components registered on the third list are currently reachable and generating a fourth list of currently reachable home network components.

Further, there is provided a home network apparatus, wherein the apparatus transmits advertisement packets upon connection of home network components to a home network or transmits response messages to a discovery packet. The home network apparatus further comprises a control point core for transmitting the discovery packets to discover the home network components existing on the home network, and extracting and storing a second list of the home network components responding to the discovery packets, and a controlled device information transmit/receive module for transmitting the second list stored in the control point core, wherein the control point core updates the second list with a third list when the third list is again input to the control point core instead of the transmitted second list.

According to another aspect of the present invention, there is provided an efficient home network management system comprising controlled devices for transmitting advertisement packets when they are connected to a home network, or response messages to discovery packets; a control point for transmitting the discovery packets to discover the controlled devices, and extracting and storing a second list of controlled devices; and a home network apparatus for capturing the advertisement packets, which are transmitted when the controlled devices are connected to the home network, and extracting a first list of the controlled devices residing on the home network, and for comparing the second list extracted by the control point with the first list and extracting a third list indicating differences between the first and second lists. Preferably, the control point updates the second list with the third list extracted by the home network apparatus.

According to a further aspect of the present invention, there is provided an efficient home network management system comprising first components for transmitting advertisement packets when the components are connected to a home network, or a response for messages to discovery packets; and a second component for comparing a first list of the first components extracted from the advertisement packets transmitted by the first components with a second list of the first components extracted through a discovery process to extract a third list indicating differences between the first and second lists, and updating the second list with the third list.

According to a still further aspect of the present invention, there is provided an efficient home network management method comprising (a) capturing advertisement packets, which are transmitted by first components when the components are connected to a home network, and extracting a first list of the first components residing on the home network; (b) extracting a second list of the first components residing on the home network through a discovery process; (c) comparing the first list and the second list and extracting a third list indicating differences between the first and second lists; and (d) transmitting the extracted third list to a second component.

Preferably, the extracted second list further comprises search type information. More preferably, operation (c) comprises searching a list of the first components corresponding to the search type information from the first list; and comparing the searched list and the second list of the first components extracted through the discovery process and extracting the third list. Further, operation (c) comprises confirming the currently reachable first components from the third list and generating a fourth list; and transmitting the generated fourth list to the second component.

### BRIEF DESCRIPTION OF THE DRAWINGS

The above and other objects and features of the present invention will become apparent from the following description of preferred embodiments given in conjunction with the accompanying drawings, in which:

FIG. 1 is a view schematically showing an overall configuration of an efficient home network management system according to the present invention;

FIG. 2 is a view showing a detailed configuration of a control point in the efficient home network management system according to the present invention;

FIG. 3 is a view showing a detailed configuration of a monitoring module in the efficient home network management system according to the present invention;

FIG. 4 is a view showing a detailed configuration of a list compare module in the efficient home network management system according to the present invention;

FIG. 5 is a view illustrating the packet capture operation of the monitoring module in the efficient home network management system according to the present invention;

FIG. 6 is a view illustrating the controlled device discovery operation of the control point in the efficient home network management system according to the present invention;

FIG. 7 is a view illustrating the list compare operation among the control point, the monitoring module and the list compare module in the efficient home network management system according to the present invention;

FIG. 8 is a view illustrating the operation of a reachability check module of the list compare module in the efficient home network management system according to the present invention;

FIG. 9 is a view illustrating the operation for transmitting a fourth list checked by the list compare module to the control point in the efficient home network management system according to the present invention;

FIG. 10 is a flowchart schematically illustrating an efficient home network management method according to the present invention;

FIG. 11 is a flowchart illustrating packet capture and information extraction operations by the monitoring module in the efficient home network management method according to the present invention;

FIG. 12 is a flowchart illustrating the operation of comparing the controlled device list found by the control point and the controlled device list found by the monitoring module in the efficient home network management method according to the present invention;

FIG. 13 is a flowchart illustrating a process of checking whether the reachability check module of the list compare module is a currently reachable controlled device and a process of transmitting a list of the currently reachable controlled device to the control point in the efficient home network management method according to the present invention; and

FIG. 14 is a view schematically illustrating the conventional UPnP device discovery operation.

### DETAILED DESCRIPTION OF THE INVENTION

Hereinafter, preferred embodiments of the present invention will be explained in detail with reference to the accompanying drawings.

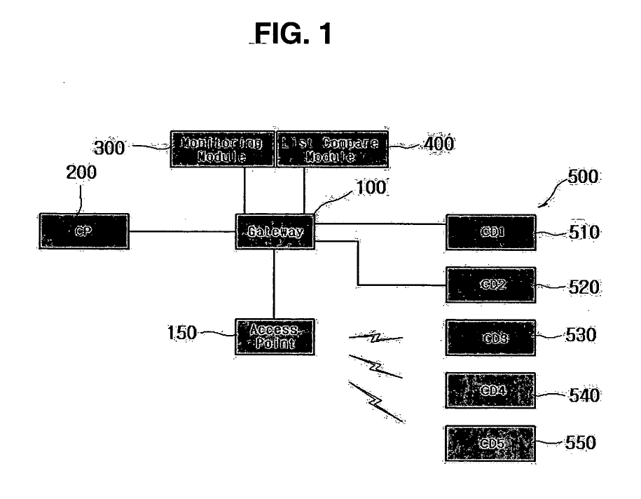

FIG. 1 is a view schematically showing an overall configuration of an efficient home network management system according to a preferred embodiment of the present invention. The home network management system comprises a gateway 100, an access point 150, a control point (CP) 200, a monitoring module 300, a list compare module 400 and a controlled device (CD) 500.

The gateway 100 serves as an interface for connecting the control point 200 and the controlled point 500. The access point 150 functions to connect the control point 200 and the controlled device 500 when they are connected in wireless mode.

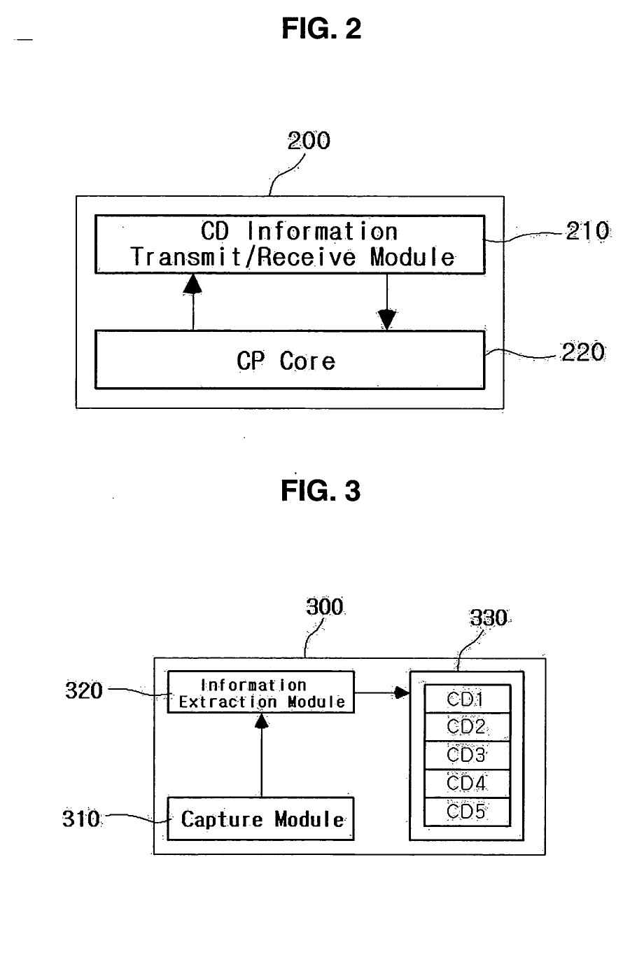

The control point 200 controls the controlled device 500 residing on the home network. More specifically, the control point 200 multicasts a search message through a discovery process for discovering controlled devices 500 residing on the home network and then stores a second list of controlled devices 500 residing on the home network. Further, the control point 200 multicasts a search message for discovering controlled devices 500 residing on the home network to control the controlled devices 500. The configuration and operation of the control point will be hereinafter described in more detail with reference to FIG. 2.

FIG. 2 is a view showing a detailed configuration of the control point in the efficient home network management system according to the present invention. The control point 200 comprises a controlled device information transmit/receive module 210 and a control point core 220. Here, the control point core 220 performs the discovery process for discovering controlled devices 500 connected to the home network and then stores a second list of the controlled devices 500 responding to the discovery process. The controlled device information transmit/receive module 210 transmits the second list of the controlled devices 500 stored in the control point core 220 and a corresponding search type to the list compare module 400. The search type may be classified into root devices, embedded devices, all controlled devices by services connected to the home network, and the like of the controlled devices 500. Root devices refer to controlled devices connected to the home network, and embedded devices are loaded into root devices for the performance of a specific function.

Referring again to FIG. 1, the monitoring module 300 captures an advertisement packet transmitted when any one of the controlled devices 500 is connected to the home network, and extracts and stores information on the corresponding controlled device 500 (e.g., IP address, device related information, service related information, etc.). The advertisement packet is used such that the controlled device 500 multicasts its own information message in order to advertise its own presence when it is connected to the home network. The configuration and operation of the monitoring module will be hereinafter described in more detail with reference to FIG. 3.

FIG. 3 is a view showing a detailed configuration of the monitoring module in the efficient home network management system according to the present invention. The monitoring module 300 comprises a capture module 310 for capturing advertisement packets transmitted from the controlled devices 500, and an information extraction module 320 for analyzing information on the captured packets (e.g., device information, service information, location information, term of validity, etc.) and extracting a first list 330 of the controlled devices 500. Here, the first list 330 includes information on the respective controlled devices (e.g., device information, service information, location information, term of validity, etc.) extracted by the information extraction module 320.

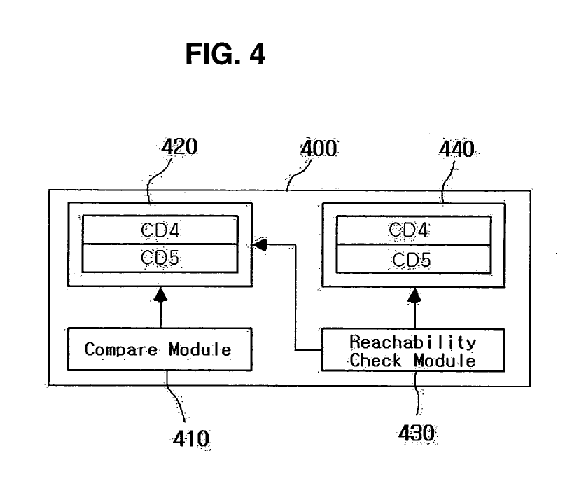

Referring again to FIG. 1, the list compare module 400 compares the second list of the controlled devices extracted during the discovery process that was performed by the control point 200 with the first list of the controlled devices extracted by the monitoring module 300, and then transfers a third list 420 indicating the difference between the first and second lists of the controlled devices to the control point 200. The configuration and operation of the list compare module will be hereinafter described in more detail with reference to FIG. 4.

FIG. 4 is a view showing a detailed configuration of the list compare module in the efficient home network management system according to the present invention. The list compare module 400 comprises a compare module 410 for comparing the second list of the controlled devices extracted by the control point 200 during the discovery process with the first list of the controlled devices extracted by the monitoring module 300 and extracting the third list 420 indicating the differences between the first and second lists, and a reachability check module 430 for checking whether the home network components registered on the third list 420 are currently reachable and generating a fourth list 440 of the currently reachable home network components.

Meanwhile, the monitoring module 300 and the list compare module 400 may exist on individual network apparatuses, respectively. Further, the monitoring module 300 and the list compare module 400 may be included in the control point 200 or the controlled device 500.

Referring again to FIG. 1, the controlled devices 500 control the operation of given devices existing on the home network. The controlled devices 500 function to transmit either an advertisement packet to the monitoring module 300 in a multicast mode when connected to the home network or a corresponding response message during the discovery process performed by the control point 200.

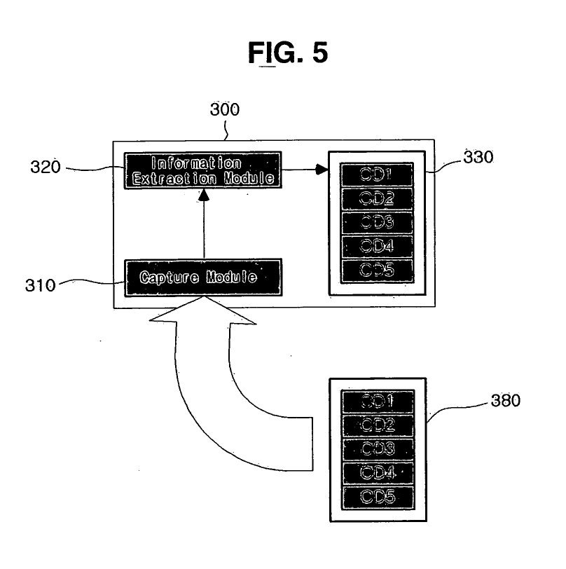

FIG. 5 shows the packet capture operation of the monitoring module in the efficient home network management system according to the present invention. The capture module 310 of the monitoring module 300 captures the advertisement packet 380 transmitted by a controlled device 500 upon its connection to the network. The information extraction module 320 analyzes device information, service information, location information, etc., which are included in the respective packets, and then extracts the first list 330 of the analyzed controlled device 500. Here, information on all the controlled devices 500 connected to the home network is registered on the first list 330.

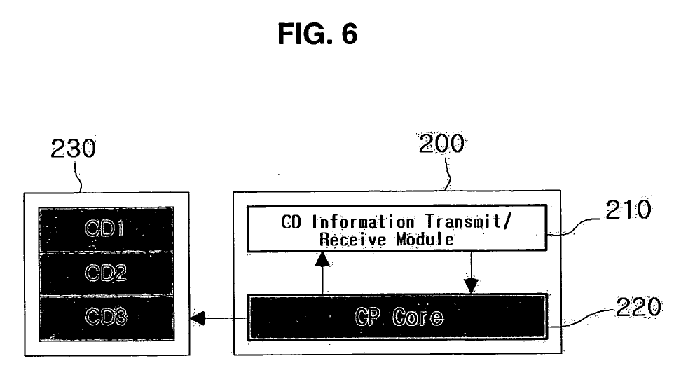

FIG. 6 shows the device discovery operation of the control point in the efficient home network management system according to the present invention. If the control point core 220 performs the discovery process in order to search for controlled devices 500 connected to the home network, the controlled devices 500 connected to the home network transmit their own information 230 to the control point core 220 in response to a search message transmitted by the control point core 220. Here, the second list 230 of the controlled devices extracted during the discovery process is stored in the control point core 220.

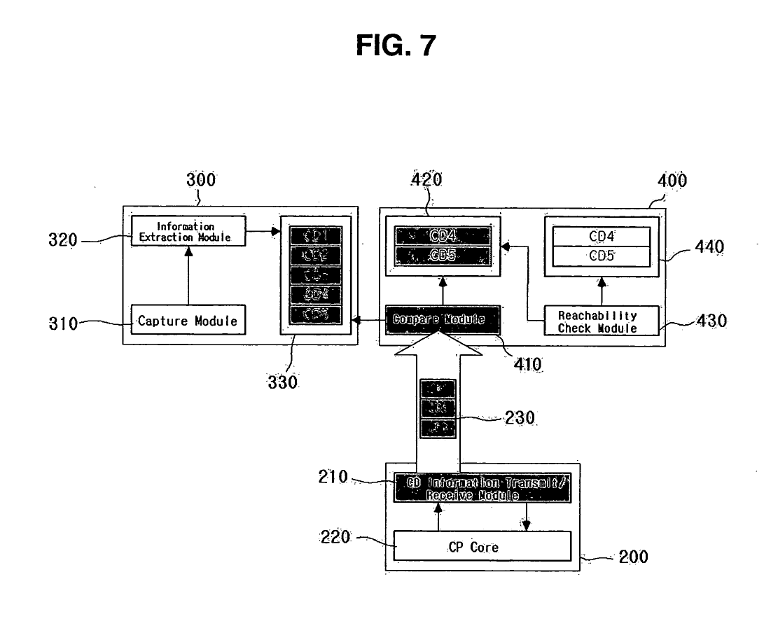

FIG. 7 shows the list compare operation among the control point, the monitoring module and the list compare module in the efficient home network management system according to the present invention. That is, in order to correctly discover or search for controlled devices 500 connected to the home network, the first list 330 of controlled devices stored in the monitoring module 300 and the second list 230 of controlled devices extracted by the control point 200 are compared with each other.

First, the control point core 220 transmits the second list 230 of controlled devices extracted during the discovery process to the controlled device information transmit/receive module 210. Then, the controlled device information transmit/receive module 210 transmits the second list 230 of the relevant controlled devices to the compare module 410.

The compare module 410 compares the received second list 230 of controlled devices transmitted from the controlled device information transmit/receive module 210 and the first list 330 of controlled devices stored in the monitoring module 300, and extracts the third list 420 indicating differences between the first and second lists of controlled devices.

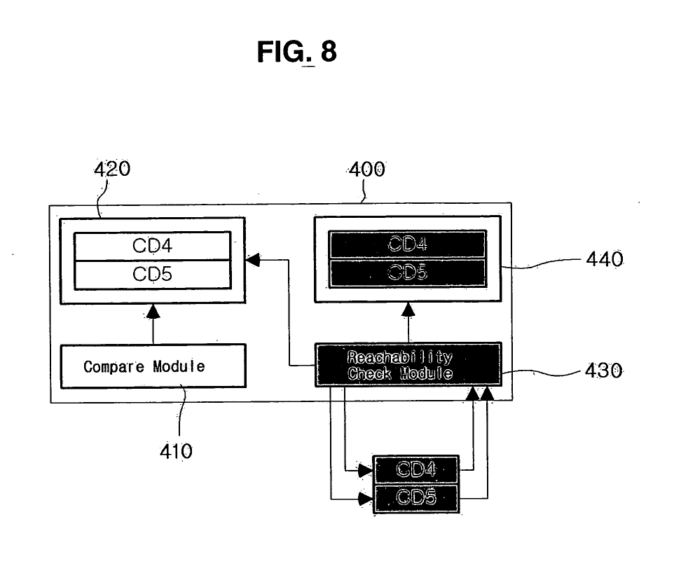

FIG. 8 shows the operation of the reachability check module of the list compare module in the efficient home network management system according to the present invention. To this end, it is checked whether a currently reachable controlled device exists in the third list 420, in order to confirm whether a controlled device that disappeared from the network is included in the third list 420 indicating differences between the first and second lists. The checking process is performed using a method such as Ping (Packet Internet groper). As a result, the fourth list of currently reachable controlled devices is finally created.

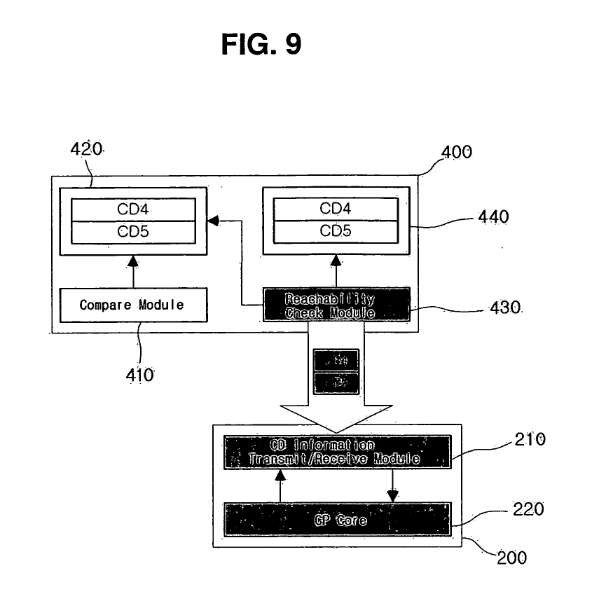

FIG. 9 shows the operation for transmitting the fourth list checked in the list compare module to the control point in the efficient home network management system according to the present invention. If the fourth list 440 of currently reachable controlled devices created from the third list 420 indicating the differences between the first and second lists is transmitted to the controlled device information transmit/receive module 210 of the control point 200, the controlled device information transmit/receive module 210 transmits the received fourth list 440 of controlled devices to the control point core 220. Thus, the control point core 220 has both the second list of controlled devices extracted during the discovery process and the received fourth list 440 of controlled devices.

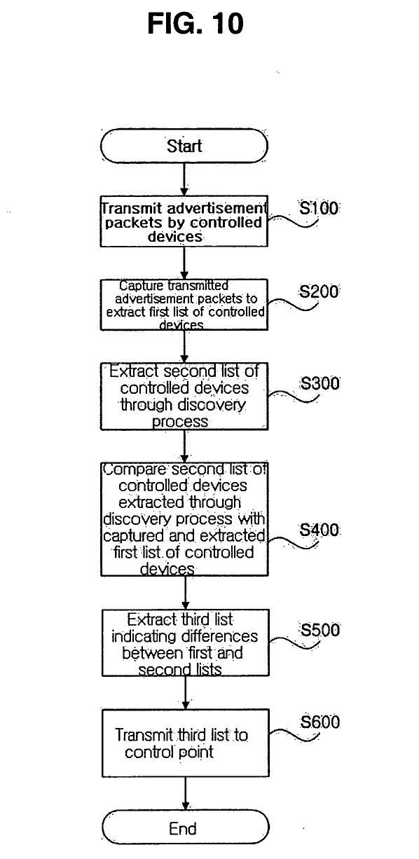

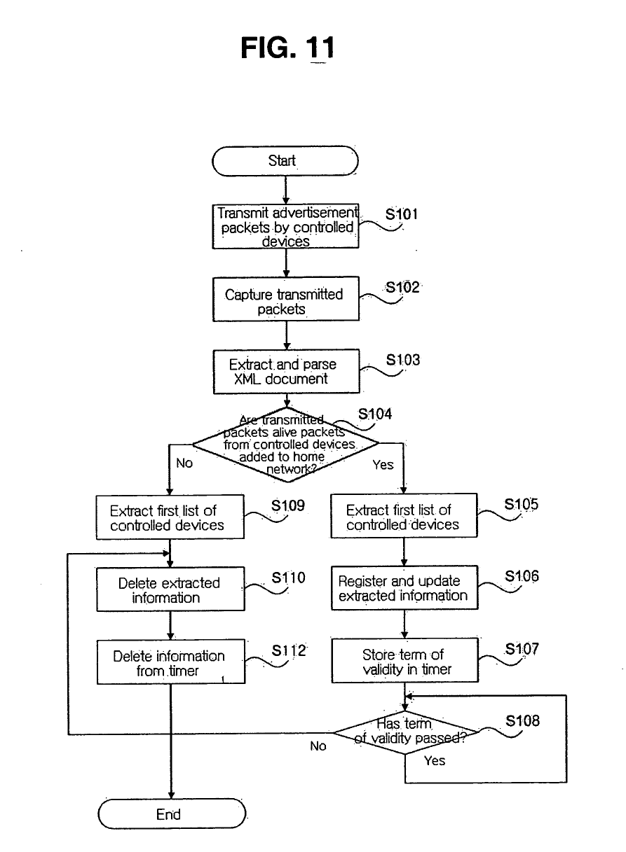

FIG. 10 is a flowchart schematically illustrating an efficient home network management method according to a preferred embodiment of the present invention. According to the home network management method of the present invention, the monitoring module 300 first captures the advertisement packets transmitted by controlled devices 500 when connected to the home network, and then extracts and stores the first list of controlled devices residing on the home network (S100, S200). Steps S100 and S200 will be hereinafter described in more detail with reference to FIG. 11.

A controlled device 500 connected to the home network transmits an advertisement packet informing the location of a description file in which its own device information, service information and additional related information are specifically described (S101). Here, the advertisement packet may be classified into an alive packet from a device added to the home network and a byebye packet from a device removed from the home network.

Then, the capture module 310 of the monitoring module 300 captures the advertisement packets transmitted from the controlled devices 500 and then transmits the captured packets to the information extraction module 320, which in turn analyzes the received packets and extracts the information on each of the controlled devices 500 (S102, S103). Here, the information extraction module 320 includes an XML parser capable of parsing an XML document and a timer for checking the term of validity from the parsed information. Thus, the information extraction module 320 extracts the contents written in the XML document from the received packets and then parses them.

Thereafter, it is determined whether the captured packets are alive packets or byebye packets based on the parsed information (S104). As a result of the determination, if a given packet is an alive packet to the home network, the information on the corresponding controlled device (e.g., device information, service information, location information, the term of validity, etc.) is analyzed and extracted and stored on the first list 330 of controlled device (S105, S106).

Next, the information on the term of validity of the corresponding controlled device is stored in the timer of the information extraction module 320 (S107), and it is checked at a given interval whether the term of validity has passed (S108). In this context, the term of validity means a period of time when a controlled device transmits its advertisement packet.

If the term of validity of the alive packet to the home network has passed, the information on the corresponding controlled device is deleted from the first list. On the contrary, if the term of validity of the alive packet to the home network has not yet passed, it is again checked at a given interval whether the term of validity has passed.

On the other hand, if the given packet is a byebye packet from the home network, the information on the corresponding controlled device (e.g., device information, service information, etc.) is analyzed and the analyzed information of the controlled device is then deleted (S109, S110) from the first list 330. Further, the information on the term of validity of the corresponding controlled device is deleted even from the timer of the information extraction module 320 (S112).

Next, the control point 200 extracts and stores the second list of controlled devices residing on the home network through a discovery process and then transmits the extracted list of controlled devices thus processed to the compare module 410 (S300).

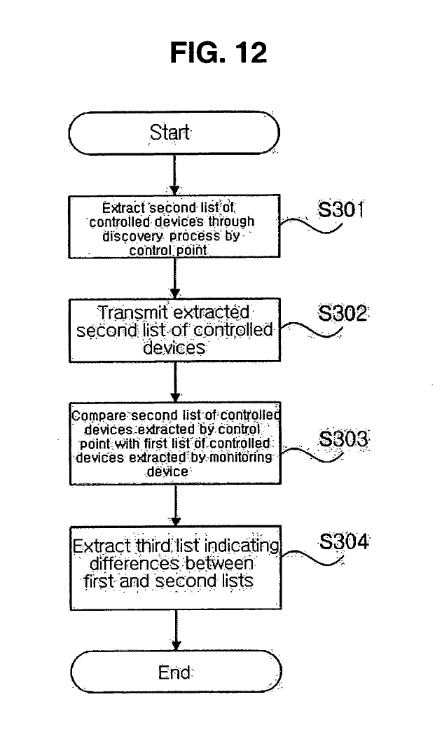

Thereafter, the transmitted second list of controlled devices and the first list of controlled devices captured and extracted by the monitoring module 300 are compared with each other (S400), and then, the third list 420 indicating differences between the first and second lists is extracted (S500). Steps S300 to S500 will be hereinafter described in more detail with reference to FIG. 12.

The control point 200 extracts the second list of the controlled devices connected to the home network through the discovery process (S301) and then transmits the extracted second list of controlled devices to the list compare module 400 (S302).

Then, the compare module 410 compares the second list of controlled devices transmitted from the controlled device information transmit/receive module 210 of the control point 200 and the first list 330 of controlled devices extracted by the monitoring module 300 (S303).

Thereafter, the third list 420 indicating differences between the first and second lists is extracted (S304). Here, the extracted third list 420 may include a controlled device that actually operates on the network but was not extracted by the control point 200, and a controlled device that was extracted by the monitoring module 300 but has subsequently disappeared from the home network without transmitting a byebye packet informing that the device will be removed from the home network.

Furthermore, the extracted second list of controlled devices further comprises search type information. Accordingly, the third list 420 may be extracted by searching a list of controlled devices corresponding to the search type information from the first list 330 and comparing the searched list and the second list of controlled devices extracted through the discovery process.

Then, the third list 420 indicating the differences between the first and second lists is transmitted to the control point 200 (S600).

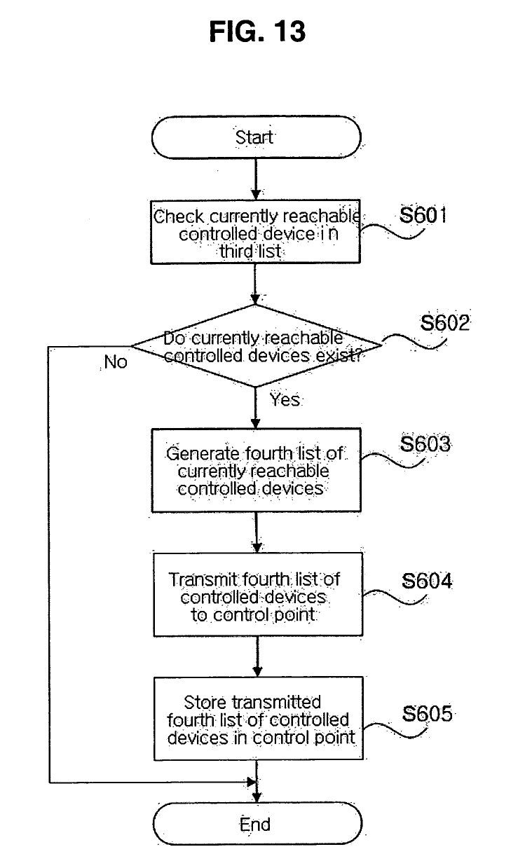

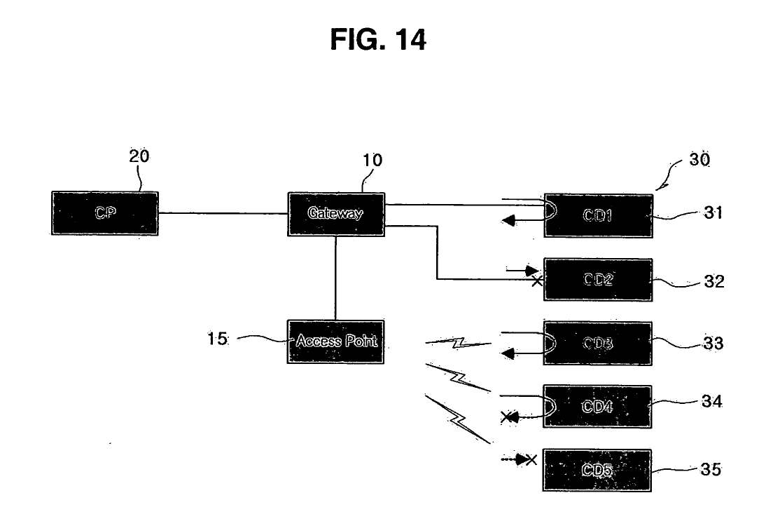

Meanwhile, it may also be checked whether a currently reachable controlled device exists in the third list 420 indicating the differences between the first and second lists of controlled devices. A process for checking whether a currently reachable controlled device exists in the third list will be hereinafter described in more detail with reference to FIG. 13.

The reachability check module 430 checks whether a currently reachable controlled device exists in the third list 420 (S601). The reason that the currently reachable controlled device is checked is to increase efficiency of device discovery because it is not necessary to provide the control point 200 with a list of the controlled devices that do not actually exist on the network. It is checked whether a response has been reached using the Ping method, etc.

As a result of the check, if a certain controlled device from which a response was reached, i.e. a currently reachable controlled device exists, the fourth list of devices is created (S602, S603).

If the fourth list of controlled devices is created, the reachability check module 430 transmits the fourth list of controlled devices to the controlled device information transmit/receive module 210 of the control point 200 (S604). Accordingly, the fourth list of the currently reachable controlled devices is additionally stored in the control point core 220 (S605). Here, the control point core 220 may access a desired controlled device in the additional fourth list of controlled devices to download the appropriate XML description file in which device information, service information, etc., are described. Thus, desired services of the relevant device can be used.

According to another preferred embodiment of the present invention, the home network apparatus may include only the monitoring module 300. In such a case, the monitoring module 300 captures advertisement packets transmitted by controlled devices 500 when they are connected to the home network, and then extracts and stores the first list of the controlled devices residing on the home network. Further, the control point 200 extracts and stores the second list of the controlled devices residing on the home network through the discovery process.

Then, the monitoring module 300 transmits the captured and extracted first list of controlled devices to the control point 200.

Accordingly, the first list of controlled devices is additionally stored in the control point core 220 of the control point 200 (S605). That is, the list of the controlled devices, which reside on the network but were not extracted during the discovery process, can be additionally secured in the control point 200.

According to the present invention so constructed, the first list of all the controlled devices connected to the home network and the second list of controlled device extracted by the control point are compared with each other, and a third list indicating differences between the first and second lists is provided to the control point. Therefore, there in an advantage in that all controlled devices connected to the home network can be correctly discovered.

Further, it is checked whether the extracted third list of controlled devices corresponds to controlled devices that currently operate on the home network. There is another advantage in that a list of controlled devices that do not currently exist on the home network is not provided to the control point.

Furthermore, the control point can obtain the fourth list of the controlled devices that were not extracted through the discovery process as well as the second list of the controlled devices that were extracted through the discovery process. Therefore, there is a further advantage in that the control point can control all controlled devices residing on the home network.

Although the present invention has been described in connection with the preferred embodiments thereof, it is apparent to those skilled in the art that various changes and modifications thereof can be made thereto without departing from the scope and spirit of the present invention defined by the claims. Therefore, simple changes to the embodiments of the present invention fall within the scope of the present invention.

What is claimed is:

1. A home network apparatus, comprising:
a monitoring module operable to capture advertisement packets transmitted by home network components when the components are connected to a home network and extract a first list of the home network components residing on the home network.

2. The home network apparatus as claimed in claim 1, wherein the monitoring module comprises:
a capture module operable to capture the advertisement packets transmitted from the home network components, and
an information extraction module operable to analyze the captured packets and extract the first list of home network components.

3. A home network apparatus, comprising:
a list compare module operable to compare a first list of home network components residing on a home network and a second list of home network components extracted through a discovery process and extract a third list of home network components indicating differences between the first and second lists.

4. The home network apparatus as claimed in claim 3, wherein the list compare module comprises:
a reachability check module operable to check whether the home network components registered on the third list are currently reachable and generate a fourth list of currently reachable home network components.

5. A home network apparatus, comprising:
a monitoring module operable to capture advertisement packets, which are transmitted by home network components when the components are connected to a home network, and extract a first list of the home network components residing on the home network, and
a list compare module operable to compare the first list of the home network components extracted by the monitoring module and a second list of home network components extracted through a discovery process and extract a third list indicating differences between the first and second lists.

6. The home network apparatus as claimed in claim 5, wherein the monitoring module comprises:
a capture module operable to capture the advertisement packets transmitted from the home network components, and
an information extraction module operable to analyze the captured packets and extract the first list of home network components.

7. The home network apparatus as claimed in claim 5, wherein the list compare module comprises:
a reachability check module operable to check whether the home network components registered on the third list are currently reachable and generate a fourth list of currently reachable home network components.

8. A home network apparatus comprising:
a control point core operable to transmit the discovery packets to discover the home network components existing on the home network, and extract and store a second list of the home network components responding to the discovery packets, and
a controlled device information transmit/receive module operable to transmit the second list stored in the control point core,
wherein the control point core updates the second list with a third list when the third list is input to the control point core instead of the transmitted second list.

9. The home network apparatus as set forth in claim 8, wherein the apparatus transmits advertisement packets upon connection of home network components to a home network or transmits response messages to a discovery packet.

10. The home network apparatus as set forth in claim 8, wherein the apparatus transmits discovery packets to discover home network components residing on a home network and then extracts a list of the home network components.

11. The home network apparatus as claimed in claim 8, wherein the control point core extracts and stores the second list according to predetermined search type information.

12. An efficient home network management system, comprising:
controlled devices operable to transmit advertisement packets when they are connected to a home network, or response messages to discovery packets;
a control point operable to transmit the discovery packets to discover the controlled devices, and extract and store a second list of controlled devices; and
a home network apparatus operable to capture the advertisement packets, which are transmitted when the controlled devices are connected to the home network, and extract a first list of the controlled devices residing on the home network, and further operable to compare the second list extracted by the control point with the first list and extract a third list indicating differences between the first and second lists.

13. The efficient home network management system as claimed in claim 12, wherein the control point updates the second list with the third list extracted by the home network apparatus.

14. An efficient home network management system, comprising:
first components operable to transmit advertisement packets when the components are connected to a home network, or a response message to discovery packets; and
a second component operable to compare a first list of the first components extracted from the advertisement packets transmitted by the first components with a second list of the first components extracted through a discovery process to extract a third list indicating differences between the first and second lists, and update the second list with the third list.

15. An efficient home network management method, comprising:
capturing advertisement packets, which are transmitted by first components when the components are connected to a home network, and extracting a first list of the first components residing on the home network;
extracting a second list of the first components residing on the home network through a discovery process; and
transmitting the extracted first list to a second component.

16. The efficient home network management method as claimed in claim 15, wherein the extracted second list comprises search type information.

17. An efficient home network management method, comprising:
(a) extracting a second list of first components residing on a home network through a discovery process;
(b) comparing a first list of the first components residing on the home network and the extracted second list, and extracting a third list indicating differences between the first and second lists; and
(c) transmitting the extracted third list to a second component.

18. The efficient home network management method as claimed in claim 17, wherein the extracted second list comprises search type information.

19. The efficient home network management method as claimed in claim 18, wherein (b) comprises:
searching a list of the first components corresponding to the search type information from the first list; and
comparing the searched list and the second list of the first components extracted through the discovery process and extracting the third list.

20. The efficient home network management method as claimed in claim 17, wherein (b) comprises:
confirming the currently reachable first components from the third list and generating a fourth list; and
transmitting the generated fourth list to the second component.

21. An efficient home network management method, comprising:
(a) capturing advertisement packets, which are transmitted by first components when the components are connected to a home network, and extracting a first list of the first components residing on the home network;
(b) extracting a second list of the first components residing on the home network through a discovery process;
(c) comparing the first list and the second list and extracting a third list indicating differences between the first and second lists; and
(d) transmitting the extracted third list to a second component.

22. The efficient home network management method as claimed in claim 21, wherein the extracted second list comprises search type information.

23. The efficient home network management method as claimed in claim 22, wherein (c) comprises:
searching a list of the first components corresponding to the search type information from the first list; and
comparing the searched list and the second list of the first components extracted through the discovery process and extracting the third list.

24. The efficient home network management method as claimed in claim 21, wherein (c) comprises:
confirming currently reachable first components from the third list and generating a fourth list; and
transmitting the generated fourth list to the second component.
